(19) United States
(12) Patent Application Publication
(10) Pub. No.: US 2026/0227015 A1
(43) Pub. Date: Aug. 6, 2026

(54) A TUBE SUPPORT FOR INSERTION INTO THE END OF A PIPE

(71) Applicant: RELIANCE WORLDWIDE CORPORATION (UK) LIMITED, West Drayton, Middlesex (GB)

(72) Inventors: Glen ANSELL, Edgware, Middlesex (GB); James FADE, West Drayton, Middlesex (GB)

(21) Appl. No.: 19/159,146

(22) PCT Filed: Feb. 23, 2024
(86) PCT No.: PCT/GB2024/050495

§ 371 Date: Aug. 22, 2025

(30) Foreign Application Priority Data
Feb. 23, 2023 (GB) 2302635.4

(51) Int. Cl. F16L 37/092; F16L 37/091; F16L 37/10

(52) U.S. Cl. CPC F16L 37/0926; F16L 37/0915; F16L 37/101; F16L 2201/10

(57) ABSTRACT

A tube support (20) for insertion into a pipe P, and insertable into a connector. The tube support (20) comprises a tubular body (21), with a first end insertable into the pipe P, and a second end insertable with the pipe P into the connector and a head (22) to seat within the connector. A ring (23) surrounds the tubular body (21) and is spaced from the head (22) towards the first end. Alternatively, the ring (85) may be at the second end. The ring (23) is displaceable once an axial force on the ring exceeds a predetermined value. The movement of the ring (23) creates a noise caused by abrupt motion of the ring. A connector with the tube support and a method of connection are also disclosed.

The present disclosure relates to a tube support for insertion into the end of a pipe. The disclosure also extends to a connector comprising the tube support and a method of making a connection using the connector.

Connectors are well known in the art for making a connection at the end of a pipe. A push-fit connector is configured such that the pipe is pushed into a connector body and will automatically be sealed and gripped simply by the pushing motion. These are very quick and reliable to fit and, as a consequence, are extremely popular across a variety of plumbing applications.

It is possible that an installer may not fully push the pipe into the fully engaged position within the connector. This can lead to a subsequent failure as the pipe may be inadequately gripped and/or sealed. It is therefore desirable to provide some form of indication that the pipe has been fully inserted.

This may take the form of a visual indication in which part of the pipe, or an indicator element is visible at a part of the connector to indicate the fully inserted position.

Alternatively, part of the connector can be positioned such that it is either broken off or snapped into place when the pipe reaches the engaged position. Such an arrangement is shown in WO 2022/018412.

This is relatively easy to do in an inner diameter (ID) connector which seals with the inner wall of the pipe as the distal end of the pipe is in the sealed part of the connector. However, for an outer diameter (OD) connector (i.e., a connector which seals on the outer wall of the pipe), this is not an option as the distal end of the pipe is not in the sealed part of the connector.

One attempt to provide an audible indication of a fully inserted pipe in an OD connector is disclosed in WO 2009/024787. OD connectors have a tube support inserted into the open end of the pipe. This is in the form of a tubular component which fits inside the pipe and prevents the pipe from deforming inwardly such that it can reliably seal with an O-ring positioned around the outer diameter of the pipe in the vicinity of the tube support. In WO 2009/024787, the protruding head of the tubular support is provided with a groove. The connector body is provided with an annular bush which has a number of resilient tongues which are configured to snap into engagement with the groove on the head of the tubular support when the pipe is fully inserted in order to provide an audible indication that the pipe is fully engaged. The bush has a relatively complex shape and is fitted within the outer body. This increases the complexity of the connector body and will also increase the overall diameter of the connector body. Also, because the bush is required to seat within the connector body, the connector body requires a particular geometry in order to accommodate this. As such, this arrangement cannot be used on existing connectors.

WO 2021/183911 has a tubular support with a groove in its head that engages a protrusion in the housing. Whilst this reduces the complexity of the connector as compared to WO 2009/024787, the tubular support would still need to be used with a specifically configured connector body.

WO2009/068932 and US2004/245766 disclose OD connectors which have noise generating features within the housing. Again, these require specially designed connectors. Further, because the noise generating features are in the housing the user has no way of knowing whether the noise generating component has become dislodged or damaged prior to insertion of the pipe. There is also no visibility of the engagement between the pipe and the tubular element over which it is inserted. Therefore, if the pipe is deformed or damaged, it may abut the end of the tubular element rather than sliding over it thereby activating the noise generating element prematurely.

JP2004/232746 JP2002/031282 and US2005/035597 show similar designs to WO2009/068932 and US2004/245766 but for ID connectors.

The present disclosure is therefore aimed at providing a tube support for insertion into the end of a pipe to provide an audible indication of full pipe insertion which does not suffer one or more of the above problems.

According to a first aspect of the present disclosure, there is provided a tube support for insertion into the end of a pipe, and being insertable into the body of a connector, the tube support comprising a tubular body extending in an axial direction, a first end of which is insertable into the end of the pipe, and a second end of which is insertable with the pipe into the body and comprises a head to seat within the body of the connector, and a ring surrounding the tubular body and spaced from the head towards the first end, the ring being displaceable along the tubular body towards the head once an axial force on the ring exceeds a predetermined value, the movement of the ring towards the head being configured to create a noise caused by abrupt motion of the ring.

The present disclosure therefore provides a tube support which can create an audible indication that a pipe has been fully inserted. However, in contrast to the prior art, this can be done using only features provided on the tube support itself. As it does not require any modification in the connector body, it can be used with existing connector bodies. Although the connector body could be modified if desired, this is not necessary for the operation of the noise generation. Further, it is cost effective as it can be implemented only by providing relatively small modifications to the tube support. The noise is generated by movement of the components which are on the outside of the tubular body and as such, this will have little or no effect on the sealing operation such that an audible indication can be provided without compromising long term performance.

Also, the support is insertable into the pipe and the support is insertable with the pipe into the body. This means that a user is able to determine that the ring is undamaged and that the pipe is correctly engaged with the support prior to insertion into the body. In the prior art just the pipe is inserted into the connector. The pipe may not have a truly circular cross section, and/or may not have a truly squared end which may cause problems when this is inserted into the connector. The present disclosure, by contrast, allows one component (the support) with a well-defined geometry to interact with a second component (the body) with a well-defined geometry which provides an easier and more reliable assembly process.

The use of a ring provides a component that can readily be retained on the tubular support before and after the insertion process. This avoids any loose fragments from entering the pipework.

The ring may be a complete ring surrounding the entirety of the tubular body or it could be a split ring in the sense that it has a gap at some point around its circumference. It should be a single piece and should surround at least half of the circumference of the tubular body even when the pipe is fully inserted such that it will be retained on the tubular body at all times.

The head of the tube support may have the same outer diameter as the remainder of the tube support. However, optionally the head has a radially outwardly extending flange. This allows the flange within the connector on which the tube support lands to be made smaller. If the outer diameter of the ring is greater than the outer diameter of the head, the tube support can be configured such that the head can pass the O-ring in the connector without any noticeable increase in force for the operator. This avoids potentially having two increases in insertion force which may be confusing for an operator.

The ring may be attached to the tubular body by one or more frangible members and the abrupt motion to create the noise is caused by the failure of the frangible members. The frangible members provide a reliable, simple way of achieving the abrupt motion of the ring. The frangible members may be portions of the reduced cross-section between the tubular body and the ring. In this case, the ring may have an axial end face to receive the end of the pipe, wherein the axial end face is positioned radially outwardly of the one or more frangible members, and is axially offset further from the head than the one or more frangible members. When the pipe engages with the axial end face of the ring, this is an axial force on the ring. However, because the frangible members are offset in this way, this generates a bending force in the frangible members which provides a more reliable way of fracturing them.

As a further possibility, the tubular body may have one or more features to fracture the ring once the ring has been advanced axially along the tubular body by more than a predetermined amount and the abrupt motion to create the noise is caused by the fracture of the ring.

The one or more features to fracture the movable ring may be one or more wedges positioned to be pressed against the ring to split the ring once the ring has been advanced axially along the tubular body by more than the predetermined amount.

Alternatively, or additionally, the feature to fracture the ring may be a ramp positioned to stretch the ring to split the ring once the ring has been advanced axially along the tubular body by more than the predetermined amount.

The ring may have a uniform structure such that it can fracture at any position. However, optionally, the ring has one or more notches to facilitate the fracture. This provides better control of the force required to fracture the ring and helps ensure that the fracture is confined to a single location.

Alternatively, the ring may be configured to slide axially along the tubular body and snap into place behind a feature on the tubular body, wherein abrupt motion to create the noise is caused by the snap engagement. In this case, the ring may be attached to the body by frangible members which only need to maintain the attachment between the ring and the tubular support but do not necessarily need to contribute to the noise caused by the abrupt motion of the ring. Alternatively, the ring is a separate component slidably retained on the tubular body.

As set out above, there are three broad ways in which the noise can be created, namely the frangible members, the fracture of the ring itself and a ring which snaps into place. In practice, two or more of these can be implemented in the same tubular support and this may be beneficial in generating an enhanced noise.

Optionally the ring is the radially outermost part of the tube support in a radial plane passing through the ring. This means that the tube support does not have a feature such as the outer sleeve of WO2009/068932. This allows good visibility of the engagement of the pipe with the support and provides a more compact arrangement.

The present disclosure also extends to a connector comprising: a hollow body to receive the end of a pipe; an O-ring in the body to seal on an outer surface of the pipe; a gripping ring in the body to grip the pipe to prevent its removal; and a tube support for insertion into the end of the pipe, and having a first end being insertable with the pipe into the hollow body, the tube support comprising a tubular body extending in an axial direction, a first end of which is insertable into the end of the pipe, and a second end of which comprises a head to seat within the hollow body, and a ring surrounding the tubular body and spaced from the head towards the first end, the ring being displaceable along the tubular body towards the head once an axial force on the ring exceeds a predetermined value, the movement of the ring towards the head being configured to create a noise caused by abrupt motion of the ring.

The requirement that a first end of the tube support is insertable with the pipe into the hollow body means that the dimensions of the tube support are such that it can be fully inserted into the fully assembled connector without any disassembly of the components of the connector. Because it can be inserted in this way with the pipe, it can also be inserted in this way without the pipe. This provides an alternative assembly method in which the tube support is inserted into the connector before the pipe is inserted into the connector and over the tube support. In WO2009/068932 and US2004/245766, the tube support is an integral part of the connector so the tube support cannot be inserted into the pipe before it is inserted into the connector.

Optionally the maximum outer diameter of the tube support is less than the minimum internal diameter of the part of the hollow body in which the pipe is received. This provides a low profile design.

The connector may be implemented with a tube support having any one of the features set out above.

The present disclosure also extends to a method of making a connection for a pipe using the above connector, the method comprising: inserting the tube support into the end of the pipe, subsequently inserting the pipe and tube support together into the tubular body until the head of the tube support lands within the hollow body, continuing to apply an axial force to the pipe to push the pipe further into the hollow body, thereby moving the ring axially along the tubular body to cause the abrupt movement of the ring and generate the noise.

The method can be implemented using a tube support having any one of the features set out above.

As set out above the ring may be a separate component slidably retained on the tubular body. This may be useful if the tube support itself is a more complex shape that cannot practically be moulded in combination with an integral ring. For example, the head may be moulded with a pair of axially spaced flanges forming a groove for an O ring to provide an additional seal between the head and the hollow body. In this case, the ring can be moulded as a separate component to allow this more complex head shape to be moulded on the tube support.

The present disclosure also extends to a tube support for insertion into the end of a pipe, and being insertable into the body of a connector; the tube support comprising a tubular body extending in an axial direction, a first end of which is insertable into the end of the pipe, and a second end of which is insertable with the pipe into the body to seat within the body of the connector; an annular flange surrounding the tubular body and spaced from the second end to receive an end of the pipe; and a ring extending axially and radially from the second end and positioned to land in the connector on insertion of the tube support into the connector, the ring being axially displaceable towards the annular flange upon further insertion of the tube support into the connector once an axial force on the ring exceeds a predetermined value, the axial movement of the ring being configured to create a noise caused by abrupt motion of the ring.

The present disclosure also extends to a connector comprising: a hollow body to receive the end of a pipe; an O-ring in the body to seal on an outer surface of the pipe; a gripping ring in the body to grip the pipe to prevent its removal; and a tube support for insertion into the end of a pipe, and being insertable with the pipe into the hollow body; and the tube support comprising a tubular body extending in an axial direction, a first end of which is insertable into the end of the pipe, and a second end of which is insertable with the pipe into the body to seat within the hollow body, an annular flange surrounding the tubular body and spaced from the second end to receive an end of the pipe; and a ring extending axially and radially from the second end and positioned to land in the hollow body on insertion of the tube support into the connector, the ring being axially displaceable towards the annular flange upon further insertion of the tube support into the hollow body once an axial force on the ring exceeds a predetermined value, the axial movement of the ring being configured to create a noise caused by abrupt motion of the ring.

As stated above, the dimensions of the tube support are such that it can be fully inserted into the fully assembled connector without any disassembly of the components of the connector. The tube support can therefore be inserted with the pipe into the connector.

Alternatively, the tube support is inserted into the connector before the pipe is inserted into the connector and over the tube support.

The present disclosure also extends to a method of making a connection for a pipe using this connector; the method comprising: inserting the tube support into the end of the pipe; subsequently inserting the pipe and tube support together into the hollow body until the ring lands within the hollow body; continuing to apply an axial force to the pipe to push the tube support further into the hollow body, thereby moving the ring axially towards the annular flange to cause the abrupt movement of the ring and generate the noise.

Placing the ring at the second end, allows the tube support to have a more complex geometry and for the ring to still be moulded integrally with the tube support. As such, although this configuration could be used with a separately formed ring, and without a seal towards the second end, it is particularly suited to a tube support with a seal towards the second end.

Optionally therefore the ring is integrally formed with the tubular body and is attached to the tubular body by at least one frangible component.

Optionally the tubular body further comprises a second annular flange surrounding the tubular body, defining with the annular flange an annular groove for an O ring.

The optional features described above in relation to the arrangement with the ring spaced from the head towards the first end may also be applied to the above arrangement in which the ring extending axially and radially from the second end Examples of pipe connectors and tube supports will now be described with reference to the accompanying drawings, in which:

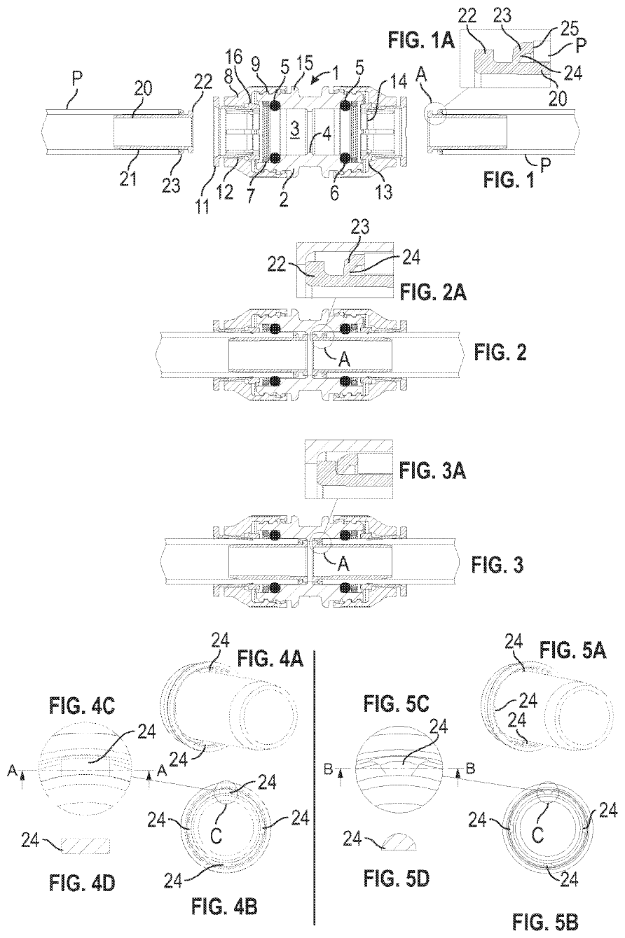

FIG. 1 is a cross sectional view of a connector body and two first tube supports with pipes attached prior to assembly;

FIG. 1A shows the detail in area A in FIG. 1;

FIGS. 2 and 2A correspond to FIGS. 1 and 1A in a partially engaged configuration;

FIGS. 3 and 3A correspond to FIGS. 1 and 1A in a fully engaged configuration;

FIG. 4A is a perspective view of the first tube support with a first tab shape before use;

FIG. 4B is a plan view of the tube support of FIG. 4A;

FIG. 4C shows the detail in area C in FIG. 4B;

FIG. 4D is a partial cross section through line AA in FIG. 4C;

FIG. 5A is a perspective view of the first tube support with a second tab shape before use;

FIG. 5B is a plan view of the tube support of FIG. 5A;

FIG. 5C shows the detail in area C in FIG. 5B;

FIG. 5D is a partial cross section through line BB in FIG. 5C;

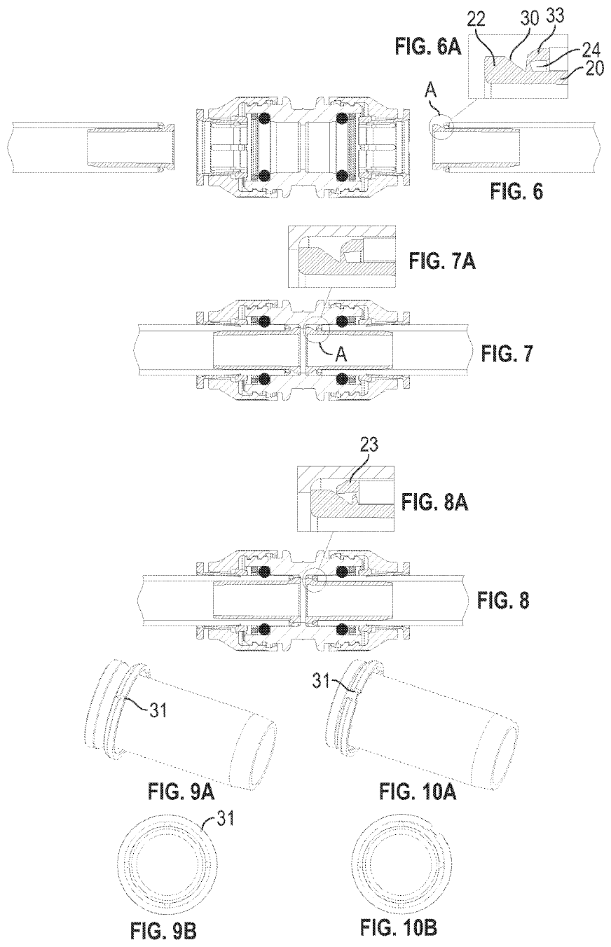

FIG. 6 is a cross sectional view of a connector body and two second tube supports with pipes attached prior to assembly;

FIG. 6A shows the detail in area a in FIG. 6;

FIGS. 7 and 7A correspond to FIGS. 6 and 6A in a partially engaged configuration;

FIGS. 8 and 8A correspond to FIGS. 6 and 6A in a fully engaged configuration;

FIG. 9A is a perspective view of the second tube support before movement of the ring;

FIG. 9B is a plan view of the tube support of FIG. 9A;

FIG. 10A is a perspective view of the second tube support after movement of the ring;

FIG. 10B is a plan view of the tube support of FIG. 10A;

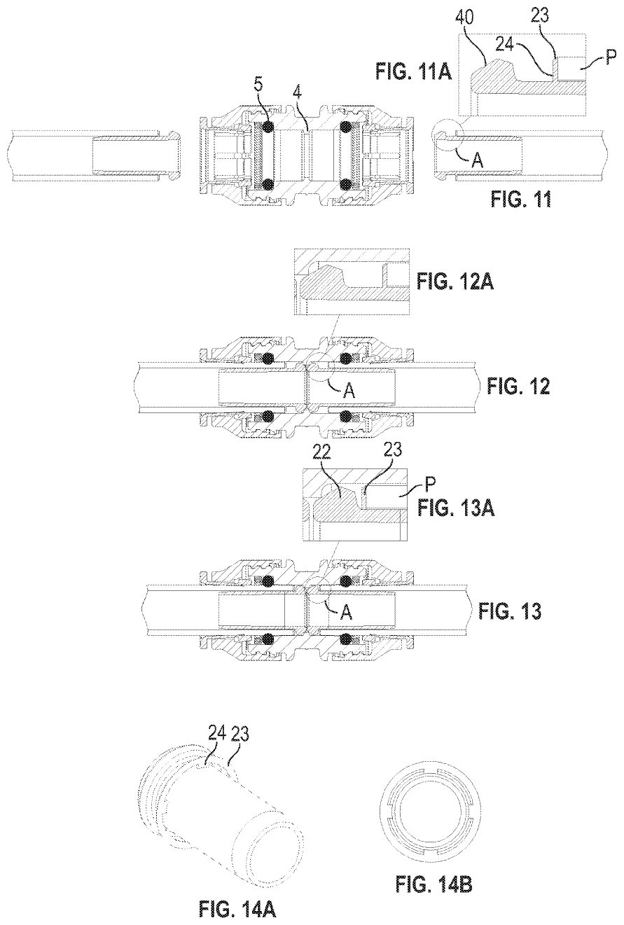

FIG. 11 is a cross sectional view of a connector body and two third tube supports with pipes attached prior to assembly;

FIG. 11A shows the detail in area A in FIG. 11;

FIGS. 12 and 12A correspond to FIGS. 11 and 11A in a partially engaged configuration;

FIGS. 13 and 13A correspond to FIGS. 11 and 11A in a fully engaged configuration;

FIG. 14A is a perspective view of the third tube support before use;

FIG. 14B is a plan view of the tube support of FIG. 14A;

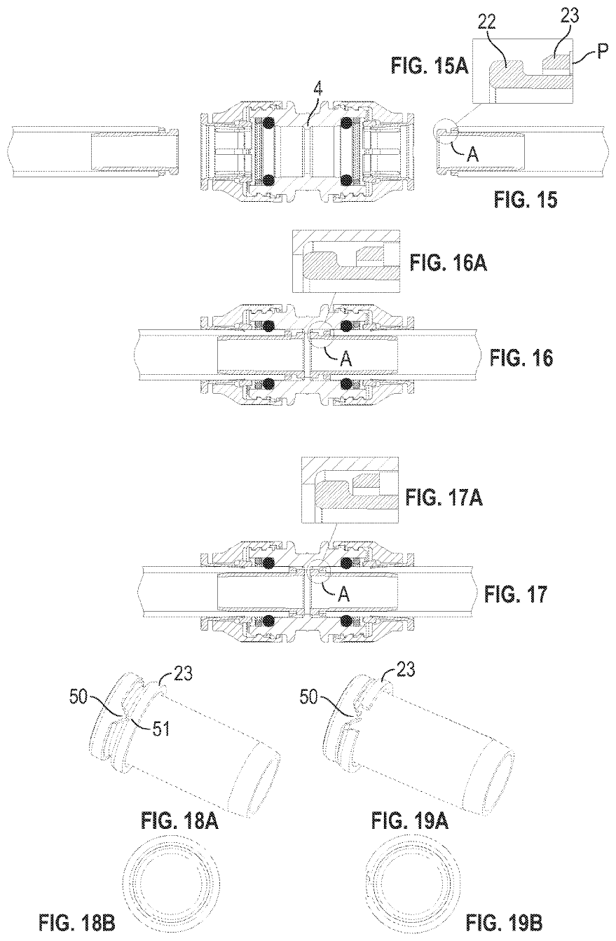

FIG. 15 is a cross sectional view of a connector body and two fourth tube supports with pipes attached prior to assembly;

FIG. 15A shows the detail in area A in FIG. 15;

FIGS. 16 and 16A correspond to FIGS. 15 and 15A in a partially engaged configuration;

FIGS. 17 and 17A correspond to FIGS. 15 and 15A in a fully engaged configuration;

FIG. 18A is a perspective view of the fourth tube support before movement of the ring;

FIG. 18B is a plan view of the tube support of FIG. 18A;

FIG. 19A is a perspective view of the fourth tube support after movement of the ring;

FIG. 19B is a plan view of the tube support of FIG. 19A;

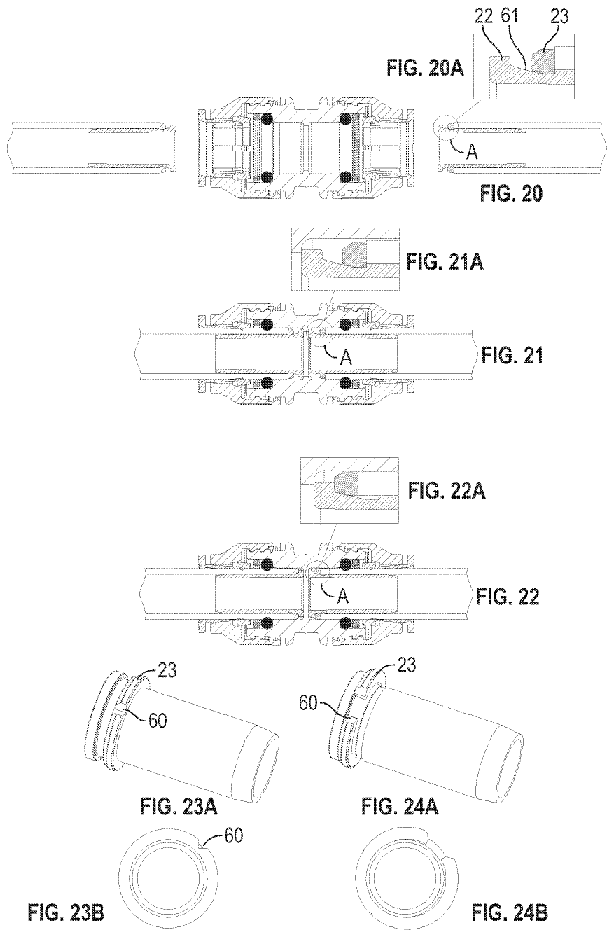

FIG. 20 is a cross sectional view of a connector body and two fifth tube supports with pipes attached prior to assembly;

FIG. 20A shows the detail in area A in FIG. 20;

FIGS. 21 and 21A correspond to FIGS. 20 and 20A in a partially engaged configuration;

FIGS. 22 and 22A correspond to FIGS. 20 and 20A in a fully engaged configuration;

FIG. 23A is a perspective view of the fifth tube support before movement of the ring;

FIG. 23B is a plan view of the tube support of FIG. 23A;

FIG. 24A is a perspective view of the fifth tube support after movement of the ring;

FIG. 24B is a plan view of the tube support of FIG. 24A;

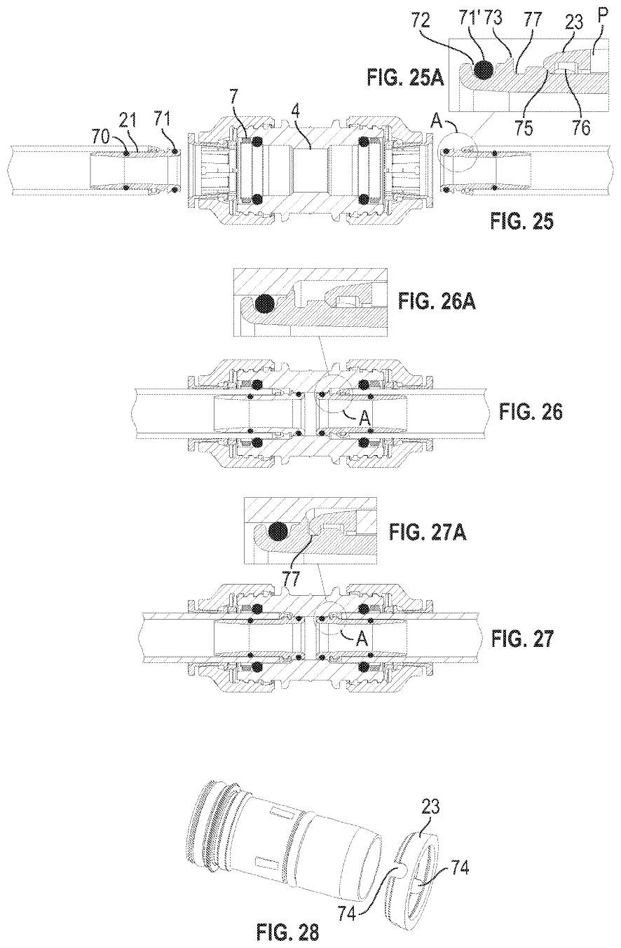

FIG. 25 is a cross sectional view of a connector body and two sixth tube supports with pipes attached prior to assembly;

FIG. 25A shows the detail in area a in FIG. 25;

FIGS. 26 and 26A correspond to FIGS. 25 and 25A in a partially engaged configuration;

FIGS. 27 and 27A correspond to FIGS. 25 and 25A in a fully engaged configuration;

FIG. 28 is a disassembled perspective view of the sixth tube support;

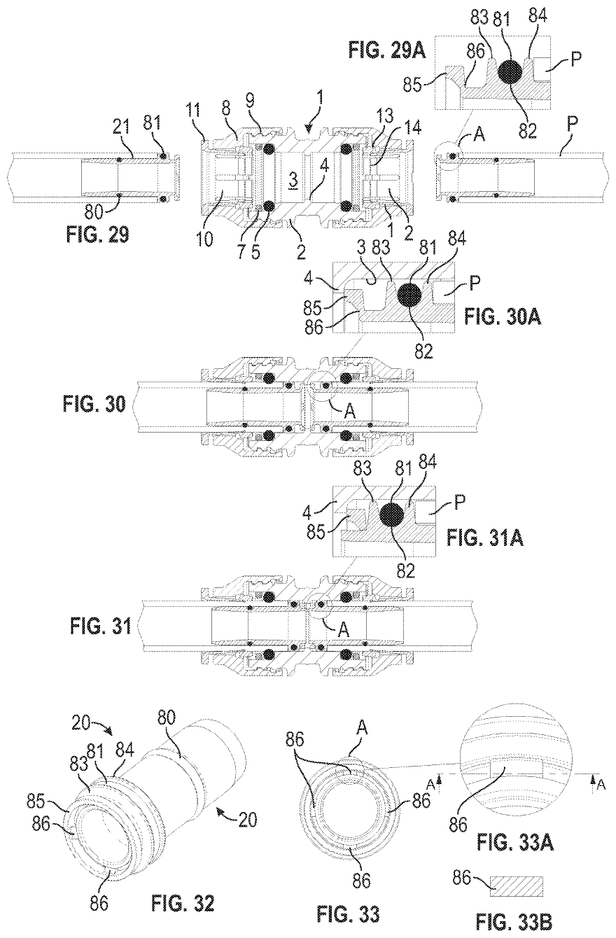

FIG. 29 is a cross sectional view of a connector body and two seventh tube supports with pipes attached prior to assembly;

FIG. 29A shows the detail in area a in FIG. 29;

FIGS. 30 and 30A correspond to FIGS. 29 and 29A in a partially engaged configuration;

FIGS. 31 and 31A correspond to FIGS. 29 and 29A in a fully engaged configuration;

FIG. 32 is a perspective view of the seventh tube support;

FIG. 33 is a cross section through the seventh tube support in the plane of the ring;

FIG. 33A shows the detail in area A in FIG. 33; and

FIG. 33B is a cross section through line A-A in FIG. 33.

The drawings show double ended connectors. The description below describes one end of the connector. The other end is the same as the end described and is not described separately.

All of the drawings show double-ended connectors with a linear configuration. In the broadest sense, only one end may be provided with the connector as described, the opposite end may have a different arrangement. As an alternative to the linear connector, the connector may include an elbow, tee, end stop or manifold with branches or any other suitable shape of fitting configuration. As an alternative, the connector may be part of a larger component or other plumbing installation or apparatus and provide a means to connect this to a pipe.

Pairs of identical tube supports are illustrated for each example. However there is no need to use the same tube support at each end of the connector as shown.

Although the term tube support is used in the specification, this has other names in the art such as tube or pipe support, liner, insert or stiffener.

Reference to a noise is a reference to a noise which is intended to be audible and recognisable in normal use. The mechanisms described below provide an abrupt movement of components to generate a short noise which is intended to be as loud as it can in the circumstances. The noise will be a click sound or similar and may also be accompanied by a tactile effect.

The connector body shown in the examples is the same in each case except for the sixth example and will only be described with reference to the first example. The connector body does not need to be as depicted in the figures as the tubular supports can be designed to be inserted in any suitable connector. For example, the connector shown uses a collet.

However, it could be provided, instead, with a grab ring. The illustrated connector has a locking cap but a connector which does not have a locking cap can be used.

The connector body 1 shown in FIG. 1 comprises a body 2 with a through bore 3. A central flange 4 surrounds the bore and provides a seat for the end of the tube support as described below. An O-ring 5 is retained on a shoulder 6 within the bore to seal against a pipe P. A spacer ring 7 is provided to keep the O-ring 5 in place. A locking cap 8 is screwed onto the end of the body 2 via complementary screw threads 9. A collet 10 is retained within an open end of the locking cap 8. The collet 10 comprises a collet ring 11 from which a plurality of resilient legs 12 extend through the locking cap 8. The legs 12 terminate at enlarged heads 13, each of which is provided on its inner face with a respective tooth 14. The pipe P is inserted into the connector body 1 as described in more detail below. Once the pipe has reached the engaged position, the locking cap 8 is screwed from the position shown in FIG. 1 into the position in which the end of the cap 8 engages with an external flange 15 which acts as an end stop for the cap. The pipe P is gripped by the teeth 14 such that any attempt to remove the pipe P causes the heads 13 to engage with a cap angle 16 in the locking cap and cause the locking cap 8 to grip the pipe P to prevent its removal.

The pipe P can only be removed if the locking cap 8 is unscrewed back to the position in FIG. 1. Axially inward pressure on the collet ring 11 is then required to hold the collet against the end of the locking cap 8 to prevent the teeth 14 from engaging with the pipe P as it is withdrawn from the connector.

This operation is the conventional manner in which a lockable push-to-fit connector operates.

A tube support 20 is inserted into the end of the pipe P. As shown in FIG. 1, the tube support 20 has a tubular body 21 which is designed to be a tight fit within the end of the pipe P. Features such as bumps are provided on the outer wall of the tubular body 21 to help retain it in place.

The tube support 20 has a head 22 in the form of an outwardly extending flange which is sized to engage with the flange 4 in the body 2 as shown in FIG. 2. In a conventional tube support, the support would be inserted into the pipe P prior to insertion such that the end of the pipe abuts the head 22.

A ring 23 extends radially outwardly from the tubular body 21 at a distance which is axially spaced to a small extent from the head 22. In this case the ring 23 is moulded at the same time as the rest of the tubular support 20. The ring 23 is attached to the tube support 20 by four tabs 24 as best shown in FIGS. 1A, 4 and 5. The number and size of tabs may vary and there may be more or less than the four illustrated. In order to mould the tube support 20 together with the ring 23 and tabs 24, the cross-section of the tabs is large enough to allow for the flow of plastic into and through the tabs 24 during the moulding process. The tabs 24 may have a rectangular shape such as shown in FIG. 4D, the semi-circular shape in FIG. 5D or some other shape.

The tabs 24 are also sized such that they will shear at the type of force which can readily be manually applied by a user and such that they break sufficiently abruptly to create an audible noise either at the point at which they shear, or at the point where they are forced against the head 22.

As a first step in the assembly process, the tube support 20 is pushed into the end of the pipe P until the ring 23 meets the end of the pipe P. Once this is done, the pipe P and tube support 20 are inserted together into the connector. The head 22 will pass through the O-ring seal 5 to allow further insertion of the pipe P and tube support 20. At this time, the user feels an increased resistance as the O-ring seal 5 engages with the ring 23 and the outer wall of the pipe P. A sharp increase in resistance is then felt as the head 22 lands on the flange 4. The user then needs to push firmly on the pipe. As shown in FIG. 1A, the pipe P engages with an engagement face 25 and the axial end of the ring 23. Further inward pressure on the pipe pushes the ring axially which, in turn, causes the ring 23 to tend to rotate about the tab 24 which will ultimately break the tab 24 to free the ring 23. When this happens, it will be noticeable to the user who will experience the sudden drop in resistance followed very quickly by abrupt increase as the broken off ring 23 abuts against the head 22. At the same time, they will also hear a noise caused by fracturing of the tabs 24 and/or the collision between the ring 23 and the head 22.

As can be seen in FIGS. 3 and 3A, the broken off ring 23 is retained between the end of the pipe P and the head 22. Thus, it does not form a loose component which may cause mess and potentially interfere with other components. Further, it does not have any undue effect on the ability of the O-ring 5 to seal the connection, or on the ability of the tube support 20 to support the pipe P.

The tube support 20 generates the noise by using features which are moulded onto the tube support. This has little or no extra cost and allows the tube support to be used to with conventional connectors as it does not require any special feature within the connector to generate the noise.

The insertion process is also very straightforward as it simply requires the user to apply pressure on the pipe to push it into the connector. Users can be trained such that they are aware of the characteristic insertion force profile as described above. After connecting just a small number of connectors, the user will soon understand the characteristic feel of a fully inserted pipe. Even in a noisy environment, if the audible indication cannot be heard, the above-mentioned force profile will provide the characteristic tactile feel indicating that the pipe P is fully engaged.

The second example is shown in FIGS. 6 to 10.

In this case, as shown in FIG. 6A, the head 22 is provided with a ramp face 30 which faces the ring 23. The ring 23 is also formed with a notch 31. As described in relation to the first example, the insertion of the pipe P will shear tabs 24 disconnecting the ring 23 from the tubular support 20. Further axial movement of the ring 23 up the ramp face 30 stretches it radially outwardly until it fractures at the notch 31 as is apparent from FIG. 10A. In this example, a noise will be generated by the fracturing of the tabs 24 and the splitting of the ring 23. In practice, it is likely that the two noises occur close enough together that they will be perceived as a single noise. However, having two potential noise generating mechanisms, should create a more noticeable noise.

The third example is shown in FIGS. 11 to 14.

In this example, the ring 23 and tabs 24 have the same thickness and are arranged in the same plane as is apparent from FIGS. 14A and 11A. In this case, the head 22 is provided with an inclined leading face 40 which extends to approximately the same radial extent as the ring 23. This helps to reduce the peak axial load on the ring 23 as the inclined leading face 40 pushes the O-ring 5 along its inclined face. This prevents the tabs 24 from shearing at this point in the insertion process.

Instead, once the head 22 lands on the flange 4, further axial pressure on the pipe P, shears the tabs 24 thereby creating a noise and pushing the ring 23 towards the head 22. This can be configured such that the ring 23 collides with the head 22 to generate a further noise.

The fourth example is shown in FIGS. 15 to 19.

In this example, the head 22 is provided with a spike 50 pointing towards the ring 23. The ring 23 may be provided with a small notch 51 to receive the spike 50. The ring 23 may not be fixed to the tubular body 21 and may simply rest against the end of the spike 50 or may be attached by one or more tabs as previously described. In this case, a smaller number of tabs may be used as their function is only to retain the ring 23 in place, not necessarily to provide a noise. Once the head 22 lands on the flange 4, further axial pressure on the pipe P on the ring 23 forces the ring 23 onto the spike 50 which causes the ring 23 to fracture as shown in FIG. 19A thereby generating a noise.

The fifth example is shown in FIGS. 20 to 24.

In this case, the ring 23 is provided with a notch 60. The ring 23 is positioned to be displaceable by the end of the pipe P over a ramp surface 61 behind the head 22. This stretches the ring 23 until it splits at the notch 60 as shown in FIGS. 24A and 24B thereby generating a noise.

The sixth example is shown in FIGS. 25 to 28.

The connector body of the sixth example has some small variations compared to the previous examples. In particular, the flange 4 is significantly longer than in the previous examples and the spacer ring 7 is also longer. Otherwise, the structure and operation of the connector is as previously described.

The tube support 20 is also configured slightly differently in that it has an inner O-ring 70 in a groove on the tubular body 21 which seals with the inner wall of the pipe P. It also has an outer O-ring 71 positioned in a groove 72 and the head 22. This seals with the inner wall of the flange 4 as shown in FIGS. 26 and 26A. The inner 70 and outer 71 O-rings provide an auxiliary sealing arrangement to support the O-ring 5. This O-ring arrangement could be implemented on any of the previously described examples.

The head 22 is provided with a radially outwardly extending flange 73 which seats on the flange 4 in the partially assembled state shown in FIGS. 26 and 26A.

The ring 23 is a separate component shown in FIG. 28 and is provided with a pair of notches 74 which allow it to expand more readily. The ring 23 is initially retained at the position shown in FIG. 25A in which its leading edge engages with a ramp 75 and it is retained in place in one or more detents 76. Once it has landed as described above, further axial pressure caused by the pipe P on the ring 23 causes the front of the ring to ride up over the ramp surface 75 until the front of the ring snaps into a groove 77 behind the flange 73 as shown in FIG. 27A. This snap engagement creates the noise.

The seventh example embodiment is shown in FIGS. 29 to 33B.

As stated above, the connector body is the same as for the first five examples. This is described in relation to FIGS. 1 to 3 and, for the sake of brevity, will not be repeated here. The same reference numerals have been used to designate the same components.

A tube support 20 is inserted into the end of the pipe P. As shown in FIG. 29, the tube support 20 has a tubular body 21 which is designed to be a tight fit within the end of the pipe P. The tubular body 21 has a groove with an inner O-ring 80 to seal with the inner wall of the pipe P. It also has an outer O-ring 81 positioned in a groove 82 between two circumferential flanges 83, 84 (see FIG. 29A) spaced from the second end of the tube support. This seals with the bore 3 (as shown in FIGS. 30A and 30B). The inner 80 and outer 81 O-rings provide an auxiliary sealing arrangement to support the O-ring 5.

A ring 85 extends radially outwardly from the tubular body 21 and extends axially beyond the distal end of the tubular body 21, as shown in FIG. 29A. In this case the ring 85 is moulded at the same time as the rest of the tubular support 20. FIGS. 33-33B further show that the ring 85 is attached to the tube support 20 by four tabs 86. The number and size of tabs may vary and there may be more or less than the four illustrated, such as two, three, five, six or more tabs. In order to mould the tube support 20 together with the ring 85 and tabs 86, the cross-section of the tabs is large enough to allow for the flow of plastic into and through the tabs 86 during the moulding process.

The tabs 86 are sized and/or configured such that the tabs 86 will shear at a magnitude of force or stress which can readily be manually applied by an average person and such that they break sufficiently abruptly to create an audible noise at the point at which they shear or abut an adjacent part. The tabs 86 will shear at a force that does not substantially increase the insertion force of the pipe into the fitting.

In one example, the shear force will not exceed 225N. In another example, the shear force will not exceed 200N. However, the size of the shear force is dependent on the size of the connector with smaller connectors requiring a smaller force. Thus, in examples, the shear force may be 175N or less. The applicable shear force will not significantly change the insertion force of the pipe as compared to inserting pipe with a pipe insert that does not include severable tabs, and in example embodiment, the insertion force for pipe according to the embodiments of the present disclosure will be equivalent to the insertion force of pipe with a pipe insert that does not include severable tabs.

As a first step in the assembly process, the tube support 20 is pushed into the end of the pipe P until the flange 84 meets the end of the pipe P. Once this is done, the pipe P and tube support 20 are inserted together into the connector. In an alternative assembly mode, the tube support can be inserted into the connector and the pipe can then subsequently be inserted into the connector.

The front part of the tube support 20 will pass through the O-ring seal 5. At this time, the user feels an increased resistance as the O-ring seal 5 engages with the tube support 20 and then the outer wall of the pipe P.

A sharp increase in resistance is then felt as the ring 85 lands on the flange 4 (FIG. 30A). The user then needs to push firmly on the pipe. Further inward pressure on the pipe P on the flange 84 pushes the tube support 20 axially which, in turn, causes the ring 85 to tend to deflect (in a clockwise direction in FIG. 30A) about the tabs 86 which will ultimately shear the tabs 86 to free the ring 85. When this happens, it will be noticeable to the user who will experience a sudden drop in resistance followed very quickly by an abrupt increase as the flange 83 abuts against the broken off ring 85 which itself is trapped against the flange 4 (FIG. 31A). At the same time, they will also hear a noise or sound caused by fracturing of the tabs 86 and/or the collision between the ring 85 and the flange 83.

As can be seen in FIGS. 31 and 31A, the broken off ring 85 is retained between the flanges 4,83. Thus, it does not form a loose component which may cause mess and potentially interfere with other components. Further, it does not have any undue effect on the ability of the O-rings 5, 81 to seal the connection, or on the ability of the tube support 20 to support the pipe P.

The profile of the tube support 20 in this example with the ring 85 at the end of the component and the pair of flanges 83 and 84 forming a groove is one which can be formed by injection moulding. By contrast, because a profile such as that of the first example requires an undercut area to create the ring 23 (see FIG. 1A) this cannot have a groove for a seal formed by a pair of flanges if it is to be injection moulded as such a complex shape is impossible to mould using normal moulding techniques The tube support 20 generates the noise by using features which are moulded onto the tube support. This has little or no extra cost and allows the tube support to be used to with conventional connectors as it does not require any special feature within the connector to generate the noise. As will be appreciated from a comparison of the sixth and seventh examples, the seventh example does not require modification of the connector body so can be used with a conventional body.

The idea of the ring being positioned at the distal end of the tube support has been described in relation to a ring with breakable tabs 86 which are similar to those used in the first example. However, the ring could be configured to break in a manner according to any of the other examples.

1. A tube support for insertion into the end of a pipe, and being insertable into the body of a connector, the tube support comprising;
a tubular body extending in an axial direction, a first end of which is insertable into the end of the pipe, and a second end of which is insertable with the pipe into the body and comprises a head to seat within the body of the connector; and
a ring surrounding the tubular body and spaced from the head towards the first end, the ring being displaceable along the tubular body towards the head once an axial force on the ring exceeds a predetermined value, the movement of the ring towards the head being configured to create a noise caused by abrupt motion of the ring.

2. A tube support according to claim 1, wherein the head has a radially outwardly extending flange, wherein the outer diameter of the ring is greater than the outer diameter of the head.

3. (canceled)

4. A tube support according to claim 1, wherein the ring is attached to the tubular body by one or more frangible members and the abrupt motion to create the noise is caused by the failure of the frangible members, wherein the one or more frangible members are portions of reduced cross sections between the tubular body and the ring.

5. (canceled)

6. A tube support according to claim 4, wherein the ring has an axial end face to receive the end of the pipe, wherein the axial end face is positioned radially outwardly of the one or more frangible members, and is axially offset further from the head than the one or more frangible members.

7. A tube support according to claim 1, wherein the tubular body has one or more features to fracture the ring once the ring has been advanced axially along the tubular body by more than a predetermined amount and the abrupt motion to create the noise is caused by the fracture of the ring.

8. A tube support according to claim 7, wherein the one or more features to fracture the movable ring is one or more wedges positioned to be pressed against the ring to split the ring once the ring has been advanced axially along the tubular body by more than the predetermined amount.

9. A tube support according to claim 7, wherein the one or more features to fracture the ring is a ramp positioned to stretch the ring to split the ring once the ring has been advanced axially along the tubular body by more than the predetermined amount.

10. A tube support according to claim 7, wherein the ring has one or more notches to facilitate the fracture.

11. A tube support according to claim 1, wherein the ring is configured to slide axially along the tubular body and snap into place behind a feature on the tubular body, wherein abrupt motion to create the noise is caused by the snap engagement, wherein the ring is a separate component slidably retained on the tubular body.

12. (canceled)

13. A tube support according to claim 1, wherein the ring is the radially outermost part of the tube support in a radial plane passing through the ring.

14. A connector comprising:
a hollow body to receive the end of a pipe;
an O-ring in the body to seal on an outer surface of the pipe;
a gripping ring in the body to grip the pipe to prevent its removal;
a tube support for insertion into the end of a pipe, and being insertable with the pipe into the hollow body, the tube support comprising a tubular body extending in an axial direction, a first end of which is insertable into the end of the pipe, and a second end of which comprises a head to seat within the hollow body; and
a ring surrounding the tubular body and spaced from the head towards the first end, the ring being displaceable along the tubular body towards the head once an axial force on the ring exceeds a predetermined value, the movement of the ring towards the head being configured to create a noise caused by abrupt motion of the ring.

15. A connector according to claim 14, wherein the maximum outer diameter of the tube support is less than the minimum internal diameter of the part of the hollow body in which the pipe is received.

16. (canceled)

17. A method of making a connection for a pipe using a connector according to claim 14, the method comprising:
inserting the tube support into the end of the pipe;
subsequently inserting the pipe and tube support together into the hollow body until the head of the tube support lands within the hollow body;
continuing to apply an axial force to the pipe to push the pipe further into the hollow body, thereby moving the ring axially along the hollow body to cause the abrupt motion of the ring and generate the noise.

18. A tube support for insertion into the end of a pipe, and being insertable into the body of a connector, the tube support comprising:
a tubular body extending in an axial direction, a first end of which is insertable into the end of the pipe, and a second end of which is insertable with the pipe into the body to seat within the body of the connector;
an annular flange surrounding the tubular body and spaced from the second end to receive an end of the pipe; and
a ring extending axially and radially from the second end and positioned to land in the connector on insertion of the tube support into the connector, the ring being axially displaceable towards the annular flange upon further insertion of the tube support into the connector once an axial force on the ring exceeds a predetermined value, the axial movement of the ring being configured to create a noise caused by abrupt motion of the ring.

19. A tube support according to claim 18, wherein the ring is integrally formed with the tubular body and is attached to the tubular body by at least one frangible component.

20. A tube support according to claim 18, wherein the tubular body further comprises a second annular flange surrounding the tubular body, defining with the annular flange an annular groove for an O ring.

21. A connector comprising:
a hollow body to receive the end of a pipe;
an O-ring in the body to seal on an outer surface of the pipe;
a gripping ring in the body to grip the pipe to prevent its removal; and
a tube support for insertion into the end of a pipe, and being insertable with the pipe into the hollow body; and
the tube support comprising:
a tubular body extending in an axial direction, a first end of which is insertable into the end of the pipe, and a second end of which is insertable with the pipe into the body to seat within the hollow body;
an annular flange surrounding the tubular body and spaced from the second end to receive an end of the pipe; and
a ring extending axially and radially from the second end and positioned to land in the hollow body on insertion of the tube support into the connector, the ring being axially displaceable towards the annular flange upon further insertion of the tube support into the hollow body once an axial force on the ring exceeds a predetermined value, the axial movement of the ring being configured to create a noise caused by abrupt motion of the ring.

22. A connector according to claim 21, wherein the ring is integrally formed with the tubular body and is attached to the tubular body by at least one frangible component.

23. A connector according to claim 21, wherein the tubular body further comprises a second annular flange surrounding the tubular body, defining with the annular flange an annular groove for an O ring.

24. A method of making a connection for a pipe using a connector according to claim 21, the method comprising:
inserting the tube support into the end of the pipe;
subsequently inserting the pipe and tube support together into the hollow body until the ring lands within the hollow body; and
continuing to apply an axial force to the pipe to push the tube support further into the hollow body, thereby moving the ring axially towards the annular flange to cause the abrupt motion of the ring and generate the noise.
